(19) United States
(12) Patent Application Publication
(10) Pub. No.: US 2016/0236259 A1
(43) Pub. Date: Aug. 18, 2016

(54) Method and Apparatus for Attaching a Nut in a Hydro-Forming Tool

(71) Applicant: Ford Motor Company, Dearborn, MI (US)

(72) Inventor: Dragan B. STOJKOVIC, Taylor, MI (US)

(21) Appl. No.: 14/620,928

(22) Filed: Feb. 12, 2015

(51) Int. Cl. B21D 26/035; B23P 19/06; B21D 28/28

(52) U.S. Cl. CPC B21D 26/035; B21D 28/28; B23P 19/06

(57) ABSTRACT

A method, a punch and a tool are disclosed for forming a hydro-formed assembly. A first opening is punched in a first wall of a tubular part with an outer punch. A second opening is punched in a second wall of the tubular part with a nut retainer that holds a nut with a clinching feature that is concentric with the outer punch. The nut is clinched by the nut retainer to an inner surface of the second wall of the tubular part.

### TECHNICAL FIELD

This disclosure is directed to a method and apparatus for punching openings in a tubular part in a hydro-forming tool and installing a nut or other threaded fastener inside the tubular part.

### BACKGROUND

Tubular parts may be formed in a hydro-forming operation performed in a hydro-forming tool. A hydro-formed part may replace multiple conventionally stamped parts in a single part thereby reducing the number of separate parts and process steps required to make an assembly. In addition, hydro-formed parts may provide increased strength and may reduce the weight of a part.

One disadvantage of prior art hydro-formed parts is that fasteners, such as nuts and bolts, must be installed after the hydro-forming operation is complete and the tubular part is removed from the hydro-forming tool. Post hydro-forming operations also add to the cycle time for manufacturing a hydro-formed assembly. Post hydro-forming operations add to the capital equipment cost for making an assembly. Increased cycle times and capital equipment costs add to the cost of manufacturing a hydro-formed assembly.

In addition, attaching fasteners to a hydro-formed part may be a problem if the fasteners must be assembled to meet close tolerances. The hydro-formed part and fasteners may need to be manipulated multiple times to install a nut on or within a tubular part. Installing a nut inside a tubular part is problematic because of the difficulty in locating, retaining and securing the nut inside the tubular member.

This disclosure is directed to solving the above problems and other problems as summarized below.

### SUMMARY

According to one aspect of this disclosure, a method of making a hydro-formed assembly is provided that includes the following steps. In the first step, a first opening is punched in a first wall of a tubular part with an outer punch. In a second step, a nut is clinched to an inner surface of the second wall of the tubular part and a second opening is punched in a second wall of the tubular part with a clinching feature provided on the nut around a bolt receiving opening defined by the nut.

According to other aspects of the method, an additional step of hydro-forming the tubular part in a hydro-forming tool is performed before the first opening is punched in the first wall. The method may further comprise loading the nut onto a nut retainer disposed within the outer punch before punching the first opening in the first wall.

According to another aspect of this disclosure, a tool for hydro-forming a part is disclosed. The tool comprises a hydro-forming die retained in a hydro-forming tool and a dual action punch operated by the tool. The dual action punch includes an outer punch and a nut retainer disposed inside the outer punch. An annular recess is provided on the die on an opposite side of the part from the dual action punch to facilitate securing the nut to an inner surface of the part. The nut defines a fastener receiving opening and includes a clinching feature disposed around the fastener receiving opening that punches an opening in the part.

According to other aspects of this disclosure as it relates to a tool for hydro-forming a part, the outer punch may form a first opening in a first portion of a wall of the part and the clinching feature on the nut forms a second opening in a second portion of the wall of the part that is axially aligned with the first opening. The nut is retained by the nut retainer within the outer punch while the outer punch forms the first opening in the first portion of the wall. The nut retainer secures the nut to the inner surface of the part by clinching the nut to the inner surface.

The hydro-form tool and die include an opening through which a slug formed by the clinching feature on the nut is removed from the second opening. The hydro-forming die may also define a relief area around the opening that receives material from the part that is displaced when the nut is clinched to the inner surface of the part. Material from the part is also formed around the clinching feature on the nut to retain the nut on the part.

According to another aspect of this disclosure, a punch assembly is disclosed for attaching a nut to a part in a hydro-forming tool. The punch assembly comprises an outer punch for forming a first opening in the part and a nut retainer received within the outer punch for forming a second opening in the part when the nut is attached to the part. The nut has a clinching feature that has a smaller diameter than the outer punch. The receptacle for retaining the nut is coaxially received within the outer punch.

According to other aspects of this disclosure as it relates to the punch assembly, the nut retained by the receptacle may be clinched to the part around the second opening. The outer punch may form the first opening in a first portion of the part and the nut may form the second opening in a second portion of the part. The nut is secured to the second portion in alignment with the second opening. The nut retainer is moveable within the outer punch. The outer punch forms the first opening in the part. The nut held by the nut retainer forms the second opening in the part at a location spaced from the first opening with the first punch engaging the part around the second opening as the nut is clinched to the part.

The above aspects of this disclosure and other aspects are described below with reference to the attached drawings.

### BRIEF DESCRIPTION OF THE DRAWINGS

FIG. 1 is a fragmentary cross-section view of a hydro-forming tool including a hydro-forming die showing a tubular part prior to forming a first opening with an outer punch.

FIG. 2 is a fragmentary cross-section view of the hydro-forming die showing the tubular part after forming the first opening with the outer punch.

FIG. 3 is a fragmentary cross-section view of the hydro-forming die showing the tubular part with the outer punch engaging an inner surface of the tubular part as a nut retainer supporting a nut with a clinching feature forms a second opening in the part.

FIG. 4 is a fragmentary cross-section view of the hydro-forming die showing the tubular part after a nut is attached to an inner surface of the tubular part in alignment with the second opening.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

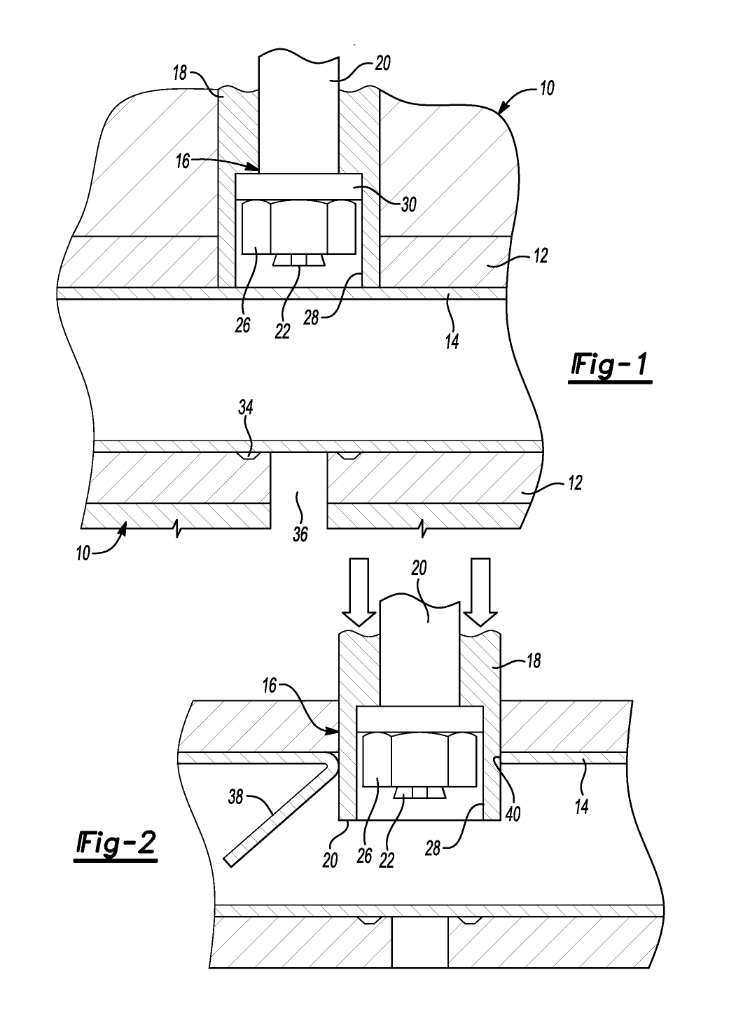

Referring to FIG. 1, a hydro-forming tool 10 is illustrated in part that is provided with a hydro-forming die 12. A tubular part 14 is shown disposed within the hydro-forming die 12. A dual action punch, generally indicated by reference numeral 16, is shown that is operated by two separate hydraulic cylinders (not shown), or other actuators, that are part of the hydro-forming tool 10. The dual action punch 16, as shown in FIG. 1, is retracted relative to the hydro-forming die 12 and prior to performing a punching operation on the tubular part 14.

The dual action punch 16 includes an outer punch 18 and a nut retainer 20 that is concentrically received within the outer punch 18. A nut 26 is retained by the nut retainer 20 and includes a clinching feature 22. The clinching feature 22 is a part of the nut and includes a cutting edge that functions as a cutting edge to punch a slug from the part to form a second opening as will be described below. The nut 26 is disposed within a cup-shaped recess 28 defined by the outer punch 18. A shoulder 30 is part of the nut retainer 20 and engages the nut 26. The shoulder 30 exerts a compressive force on the nut 26 to secure the nut 26 to an inner surface of the tubular part 14 by coining or clinching.

The hydro-forming die 12 defines an annular recess, or relief area, at 34. The relief area 34 receives material displaced when the nut 26 is pressed onto the tubular part to retain the nut 26 on the tubular part 14 inner surface. The hydro-forming die 12 defines a slug removal hole 36.

Referring to FIG. 2, the dual action punch 16 is shown after punching a slug 38 that is formed when the first opening 40 is formed in the tubular part 14. The first opening slug 38 is punched from the tubular part 14 by the outer punch 18, but is retained on the tubular part 14 by an attachment bridge. The outer punch 18 forms the first opening 40 when forced, as shown by the arrows in FIG. 2, into the tubular part 14. The nut retainer 20 initially moves with the outer punch 18, as shown in FIG. 2. The nut retainer 20 retains the nut 26 within the recess 28 magnetically or with a mechanical retention mechanism (fingers, detents or other holders).

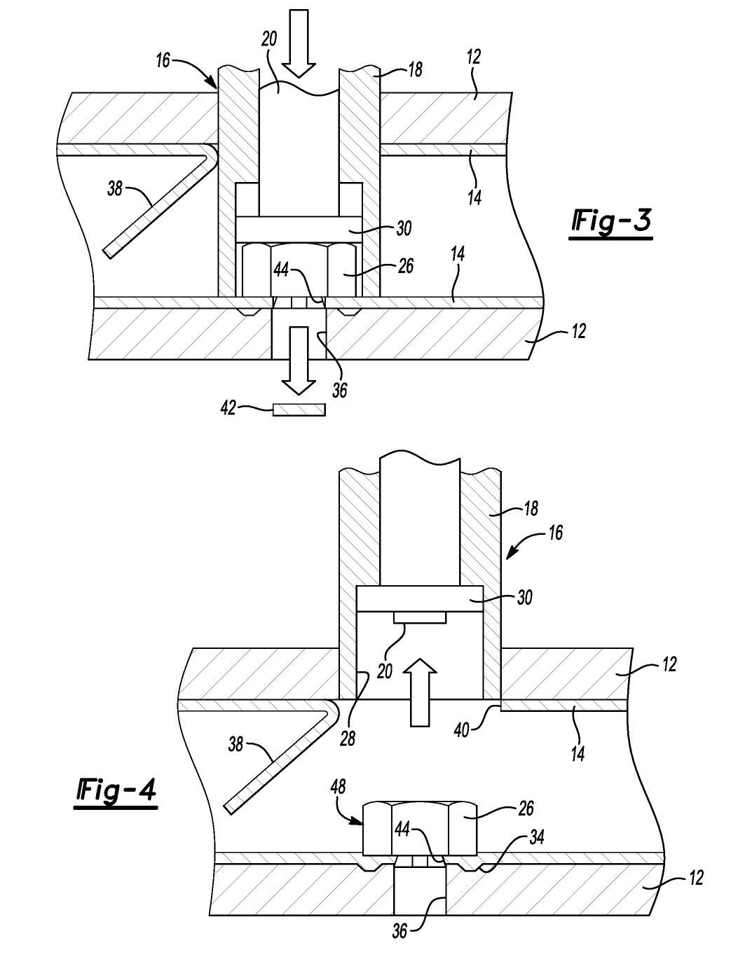

Referring to FIG. 3, the dual action punch 16 is shown with the outer punch 18 engaging an inner surface of the tubular part 14. At this point, the nut retainer 20 moves relative to the outer punch 18 in the direction indicated by the upper arrow in FIG. 3. The shoulder 30 is shown engaging the nut 26 to drive the nut into the inner surface of the tubular part 14. The nut retainer 20 is shown after the nut 26 cuts the slug 42 from the second opening 44. The slug 42 is shown after being removed from the hydro-forming die 12 through the slug removal hole 36 that is defined by the hydro-forming die 12.

Referring to FIG. 4, the dual action punch 16 is shown after attaching the nut 26 and being retracted from the tubular part 14. The dual action punch 16 moves for retraction in the direction indicated by the arrow in FIG. 4. The nut 26 is clinched to the inner wall of the tubular part 14 with a portion of the tubular part 14 being displaced into the relief area 34 defined by the hydro-forming die 12. The first opening slug 38 is retained by the tubular part 14. The first opening 40 provides access for a bolt or other fastener to be received in the nut 26. The nut retainer 20, including the shoulder 30, is initially retracted within the outer punch 18 as the dual action punch 16 is refracted from the part. At this point, the first opening 40 and second opening 44 have been formed in the tubular part 14 and the nut 26 is clinched or coined into engagement with the inner surface of the tubular part 14.

The nut 26, first opening 40 and second opening 44 are all coaxially aligned. At this point in the process, the tubular part 14 may be removed from the hydro-forming die 12 as a hydro-formed part assembly 48. After completion, the process may be repeated by loading another tubular part 14 into the hydro-forming die 12 and loading a new nut 26 into the dual action punch 16.

No post hydro-forming operations are required to assemble the nut to the tubular part 14. Because the openings 40 and 44 are both punched and the nut 26 is assembled in a single cycle of the dual action punch 16, close tolerances may be maintained as to the relative location of the holes and the nut.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

1. A method of making a hydro-formed assembly comprising:
punching a first opening in a first wall of a tubular part with an outer punch;
securing a nut to an inner surface of a second wall of the tubular part; and
punching a second opening in the second wall of the tubular part with a clinching feature formed on the nut.

2. The method of claim 1 further comprising:
hydro-forming the tubular part in a hydro-forming tool before the first opening is punched in the first wall.

3. The method of claim 1 further comprising:
loading the nut onto a nut retainer disposed inside the outer punch before punching the first opening in the first wall.

4. A tool for hydro-forming a part comprising:
a hydro-forming die retained in a hydro-forming tool; and
a dual action punch operated by the tool and received in the die, the dual action punch including an outer punch and a nut retainer disposed inside the outer punch, wherein the hydro-forming die defines a recess on an opposite side from the dual action punch, and a nut is secured to an inner surface of the part.

5. The tool of claim 4 wherein the outer punch forms a first opening in a first portion of a wall of the part and the nut forms a second opening in a second portion of the wall of the part, wherein the second opening is axially aligned with the first opening.

6. The tool of claim 5 wherein the nut is retained by the nut retainer within the outer punch while the outer punch forms the first opening in the first portion of the wall.

7. The tool of claim 5 wherein the nut retainer secures the nut to the inner surface of the part by clinching the nut to the inner surface while forming the second opening.

8. The tool of claim 7 wherein the hydro-forming die includes an opening through which a slug formed by the nut is removed from the second opening and wherein the hydro-forming die defines a relief area around the second opening that receives material from the part that is displaced when the nut is secured to the inner surface of the part.

9. A punch assembly for attaching a nut to a part in a hydro-forming tool comprising:
an outer punch for forming a first opening in the part; and
a retainer received within the outer punch that retains the nut having a clinching feature that forms a second opening in the part that is coaxially aligned with the outer punch.

10. The punch assembly of claim 9 wherein the nut retained by the retainer is clinched to the part in alignment with the second opening.

11. The punch assembly of claim 9 wherein the outer punch forms the first opening in a first portion of the part and the nut forms the second opening in a second portion of the part and secures the nut to the second portion in alignment with the first and second openings.

12. The punch assembly of claim 9 wherein the retainer is moveable within the outer punch.

13. The punch assembly of claim 12 wherein the outer punch forms the first opening in the part with the retainer holding the nut spaced from the part.

14. The punch assembly of claim 13 wherein the nut forms the second opening in the part with the outer punch engaging the part around the second opening as the nut is clinched to the part.
